(19) United States
(12) Patent Application Publication
(10) Pub. No.: US 2025/0385946 A1
(43) Pub. Date: Dec. 18, 2025

(54) REBALANCING IN A DISTRIBUTED STORAGE NETWORK BASED ON BOTH NAMESPACE RANGE AND USAGE IMBALANCES

(71) Applicant: International Business Machines Corporation, Armonk, NY (US)

(72) Inventor: Huiying Xu, Morton Grove, IL (US)

(21) Appl. No.: 18/740,583

(22) Filed: Jun. 12, 2024

(51) Int. Cl. H04L 67/1097; H04L 67/1008; H04L 67/1012

(52) U.S. Cl. CPC H04L 67/1097; H04L 67/1008; H04L 67/1012

(57) ABSTRACT

Computer-implemented methods for rebalancing of a distributed storage network (DSN) based on a combination of namespace range and usage imbalances. Aspects include calculating a usage imbalance factor for each of a plurality of storage devices in the DSN, identifying a selected namespace range from a plurality of namespace ranges of the DSN, and calculating a namespace range imbalance factor for each of the plurality of storage devices that correspond to the selected namespace range. Aspects also include calculating a combined imbalance factor for each of the plurality of storage devices, calculating an imbalance ratio for the selected namespace range by dividing a difference between a maximum combined imbalance factor and a minimum combined imbalance factor by the maximum combined imbalance factor, and based on a determination that the imbalance ratio for the selected namespace range is greater than a rebalancing threshold, rebalancing the selected namespace range.

### BACKGROUND

This disclosure relates generally to computer networks and more particularly to performing rebalancing in a distributed storage network based on a combination of namespace range and usage imbalances.

Computing devices are known to communicate data, process data, and/or store data. Such computing devices range from wireless smart phones, laptops, tablets, personal computers (PC), workstations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open-source software framework that supports distributed applications enabling application execution by thousands of computers.

In addition to cloud computing, a computer may use “cloud storage” as part of its memory system. As is known, cloud storage enables a user, via a computer, to store files, applications, etc. on an Internet storage system. The Internet storage system may include a RAID (redundant array of independent disks) system and/or a dispersed storage system that uses an error correction scheme to encode data for storage.

### SUMMARY

Embodiments of the present disclosure are directed to computer-implemented methods for rebalancing of a distributed storage network based on a combination of namespace range and usage imbalances. According to an aspect, a computer-implemented method includes calculating a usage imbalance factor for each of a plurality of storage devices in a distributed storage network (DSN), which each has a device number and the plurality of storage devices are logically arranged in ascending order based on the device number, identifying a selected namespace range from a plurality of namespace ranges of the DSN, wherein each of the plurality of namespace ranges is spread among the plurality of storage devices, and calculating a namespace range imbalance factor for each of the plurality of storage devices that correspond to the selected namespace range. The method also includes calculating a combined imbalance factor for each of the plurality of storage devices that correspond to the selected namespace range based on the usage imbalance factor and the namespace range imbalance factor that correspond to the plurality of storage devices, calculating an imbalance ratio for the selected namespace range by dividing a difference between a maximum combined imbalance factor and a minimum combined imbalance factor by the maximum combined imbalance factor, and based on a determination that the imbalance ratio for the selected namespace range is greater than a rebalancing threshold, rebalancing the selected namespace range.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 is a schematic block diagram of an embodiment of a dispersed or distributed storage network (DSN) in accordance with an embodiment of the present disclosure;

FIG. 2 is a schematic block diagram of an embodiment of a computing core in accordance with an embodiment of the present disclosure;

FIG. 3 is a schematic block diagram of an example of dispersed storage error encoding of data in accordance with an embodiment of the present disclosure;

FIG. 4 is a schematic block diagram of a generic example of an error encoding function in accordance with an embodiment of the present disclosure;

FIG. 5 is a schematic block diagram of a specific example of an error encoding function in accordance with an embodiment of the present disclosure;

FIG. 6 is a schematic block diagram of an example of a slice name of an encoded data slice (EDS) in accordance with an embodiment of the present disclosure;

FIG. 7 is a schematic block diagram of an example of dispersed storage error decoding of data in accordance with an embodiment of the present disclosure;

FIG. 8 is a schematic block diagram of a generic example of an error decoding function in accordance with an embodiment of the present disclosure;

FIG. 9A is a schematic diagram illustrating an ideal distribution of a namespace range among a plurality of storage devices of a dispersed storage network in accordance with an embodiment of the present disclosure;

FIG. 9B is a schematic diagram illustrating an actual distribution of a namespace range among a plurality of storage devices of a dispersed storage network in accordance with an embodiment of the present disclosure;

FIG. 10 is a schematic diagram illustrating an imbalanced data distribution among a plurality of storage devices having a balanced namespace range distribution in accordance with an embodiment of the present disclosure;

FIG. 11 is a graph illustrating the relationship between the range weight and the average fullness for different values of the balance adjustment in accordance with an embodiment is shown in accordance with an embodiment of the present disclosure;

FIG. 12 is a flowchart diagram illustrating a method for performing rebalancing in a distributed storage network based on a combination of namespace range and usage imbalances in accordance with an embodiment of the present disclosure; and

FIG. 13 is a flowchart diagram illustrating a method for performing rebalancing in a distributed storage network based on a combination of namespace range and usage imbalances in accordance with an embodiment of the present disclosure.

### DETAILED DESCRIPTION

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of storage devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSN managing unit 18 tracks the number of times a user accesses a non-public vault and/or public vaults, which can be used to generate a per-access billing information. In another instance, the DSN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 62, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

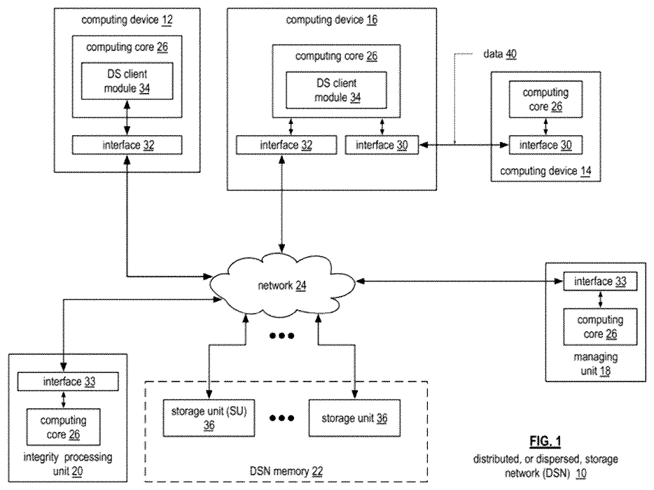

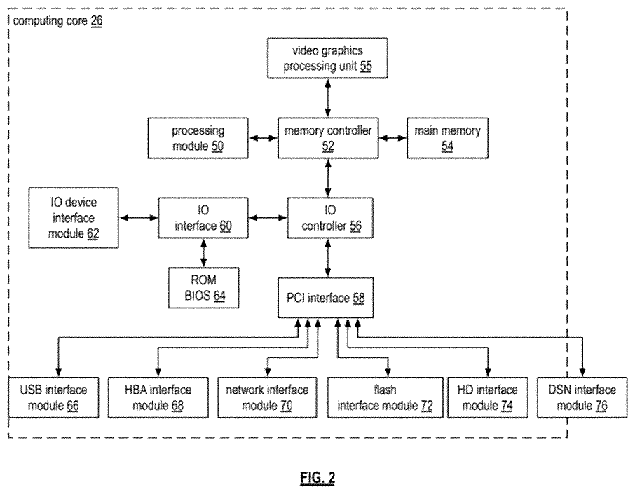

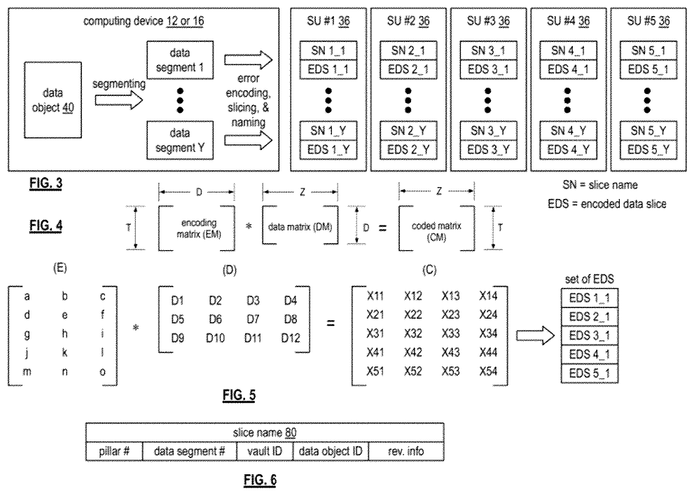

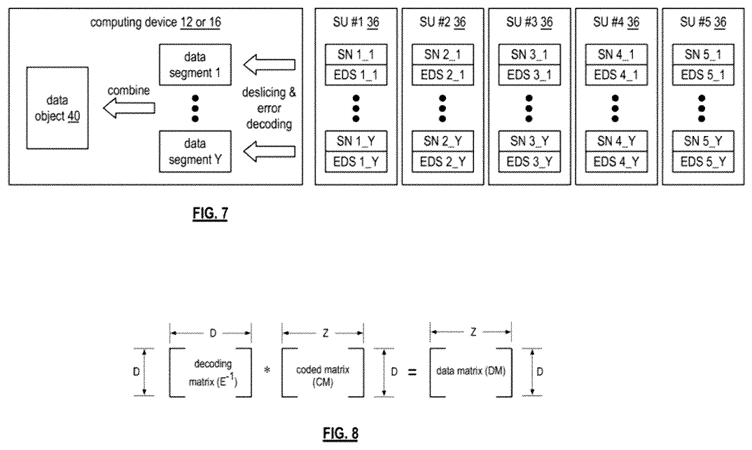

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 60 is shown in FIG. 6. As shown, the slice name (SN) 60 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

In each storage unit 36, all the storage devices 902 share the whole namespace range 901, and each owns a portion. A slice name is just like a memory address in a computing system, and the whole namespace range is just like the memory address space. Given an EDS, its slice name decides which storage device it will be stored into. The DS Client module 34 always tends to generate the slice names uniformly distributed in the whole namespace range. Therefore, the wider the portion of the whole namespace range a storage device owns; the more EDS will be stored into this storage device; vice versa. The migration of portion of namespace range can only happen between two adjacent storage devices, either migrate the left part or the whole of the portion of namespace range a storage device owns to its left neighbor storage device or migrate the right part or the whole of the portion of namespace range a storage device owns to its right neighbor storage device.

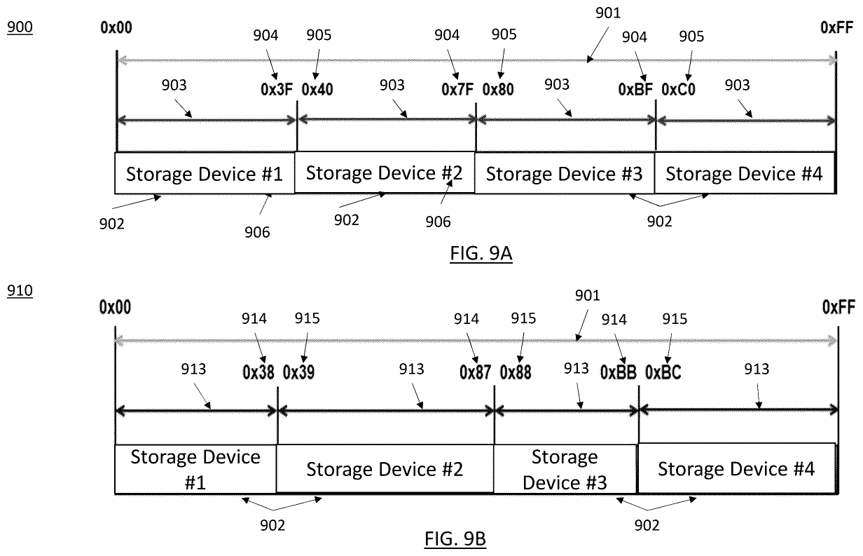

Referring now to FIG. 9A, a schematic diagram 900 illustrating an ideal distribution of a namespace range 901 among a plurality of storage devices 902 of a dispersed storage network is shown. In exemplary embodiments, the namespace range 901 is split among the storage devices 902 of the dispersed storage network proportionally based on the storage capacity of the storage devices 902. In the illustrated embodiment, the namespace range 901 ranges from address 0x00 to 0xFF and is split evenly among four storage devices 902, i.e., the four storage devices 902 have the same storage capacity. Each storage device 902 includes an ideal namespace range 903 that ranges from a minimum ideal namespace address 905 to a maximum ideal namespace address 904.

Each of the storage devices 902 is assigned a device number 906. In exemplary embodiments, the storage devices 902 are logically arranged in ascending order based on the device number 906. As a result, the maximum ideal namespace address 904 of a storage device 902 having device number N, will be one less than the minimum ideal namespace address 905 of a storage device 902 having device number N+1. Likewise, the minimum ideal namespace address 905 of a storage device 902 having device number N will be one greater than the maximum ideal namespace address 904 of a storage device 902 having device number N−1.

In exemplary embodiments, when a dispersed storage network is initially provisioned, namespace range 901 is split among the storage devices 902 proportionally based on the storage capacity of the storage devices 902, which results in the ideal distribution of a namespace range 901, as shown in diagram 900. During the operation of the dispersed storage network, the actual distribution of the namespace range 901 among the storage device 902 may deviate from the ideal distribution due to a variety of factors. For example, one of the storage devices 902 may malfunction and be brought out of service so that the namespace range portion it owns is taken by its neighbor storage devices immediately. In another example, a new storage device is added to the dispersed storage network, and it owns the zero width of namespace range portion at the beginning.

Referring now to FIG. 9B, a schematic diagram 910 illustrating an actual distribution of a namespace range 901 among a plurality of storage devices 902 of a dispersed storage network in accordance with an embodiment of the present disclosure is shown. In exemplary embodiments, the namespace range 901 is split among the storage devices 902 of the dispersed storage network. In the illustrated embodiment, the namespace range 901 ranges from address 0x00 to 0xFF and is not evenly split among four storage devices 902. Each storage device 902 includes an actual namespace range 913 that ranges from a minimum namespace address 915 to a maximum namespace address 914.

As shown in the difference between diagrams 900 and 910, the actual distribution of a namespace range 901 among a plurality of storage devices 902 is not the same as the ideal distribution of a namespace range 901 among a plurality of storage devices 902. For example, the minimum ideal namespace address 905 of storage device 1 is 0x3F and it is not equal to the minimum namespace address 915 of storage device 1, which is 0x38. The wider the namespace range portion a storage device owns, the higher probability this storage device will receive the EDS to store; vice versa. Therefore, the storage devices owning wider namespace range portions will be filled much more quickly than those storage devices owning narrower namespace range portions. If an EDS is to be stored in a near full storage device, the storing operation will probably fail, and the data may be lost.

In exemplary embodiments, based on the severity of the difference between the actual distribution and the ideal distribution of a namespace range 901 among a plurality of storage devices 902, the namespace range 901 will be rebalanced among the plurality of storage devices 902. In exemplary embodiments, the severity of the difference between the actual distribution and the ideal distribution of a namespace range is determined based on a namespace imbalance factor calculated for each of the storage devices 902. In one embodiment, the namespace imbalance factor for a storage device is calculated as the maximum namespace address minus the minimum namespace address divided by the ideal maximum namespace address minus the ideal minimum namespace address. In exemplary embodiments, the namespace imbalance factor is calculated for each storage device and based on a determination that the largest namespace imbalance factor is greater than a threshold value, the namespace range 901 will be rebalanced among the plurality of storage devices 902. In exemplary embodiment, rebalancing the namespace range 901 among the plurality of storage devices 902 includes reassigning a portion of a namespace range assigned to storage device N to one or more of storage devices N−1 or N+1. Here, the storage device N is the source storage device, and the storage device N−1 or N+1 is the destination storage device.

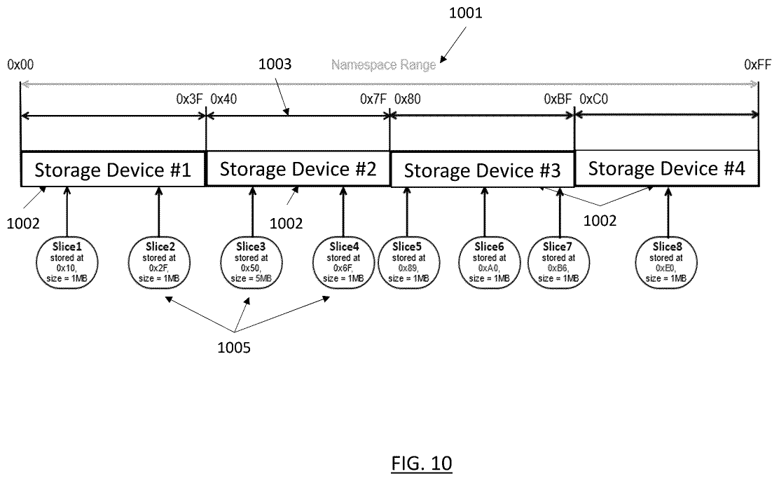

Referring now to FIG. 10, a schematic diagram illustrating an imbalanced data distribution among a plurality of storage devices having a balanced namespace range distribution in accordance with an embodiment of the present disclosure is shown. As illustrated, a namespace range 1001 is distributed among the plurality of storage devices 1002 in a balanced manner with respect to the namespace. That is, each of the plurality of storage devices 1002 has an equal portion 1003 of the namespace range 1001 associated with each storage device 1002. Storage devices 1 and 2 have the same slice distribution, i.e., both storage devices 1 and 2 include two data slices 1005, storage device 3 includes three data slices 1005 and storage device 4 only includes one data slice 1005. In addition, as illustrated, the sizes of the slices are not all the same. Accordingly, the total size of the data stored in each of the storage devices are different.

Currently, one of two different rebalancing policies are used when determining whether to rebalance data stored across storage devices in a distributed storage network. The first rebalancing policy is a namespace range rebalancing policy, and the other is a usage-based rebalancing policy. The namespace range rebalancing policy seeks to balance the namespace range distribution among the storage devices. When a balanced state is reached, the portion of namespace range owned by a storage device is decided by the ratio of the storage device capacity to the summation of all storage device capacities. If all the storage devices have equal capacities, each storage device will have the same width of namespace range. The usage-based rebalancing policy seeks to balance the storage device fullness, which is defined as the ratio of the usage of a storage device to its capacity, When the balanced state is reached, all the storage devices have the same fullness, however, the storage devices might own different widths of namespace range portions.

In a distributed storage network, when the storage devices are barely filled (e.g. fullness is less than 50%), the rebalancing is performed by the namespace range rebalancing policy. This policy will make all the storage devices own the same width of namespace range portions if they all have the same capacity. When more objects are to be stored, since the distributed storage network tends to uniformly distribute the data slices in the namespace range, the data slices will tend to be distributed uniformly among the storage devices. When the storage devices are close to being full, the rebalancing is performed by the usage-based rebalancing policy, which can prevent a single storage device from being filled too full, so that some slices to be stored in this storage device are lost.

Since the namespace rebalancing policy balances the storage devices differently from the usage-based rebalancing policy, when the storage devices are filled gradually from barely filled to almost full, the rebalancing policy is changed from the namespace range rebalancing to the usage-based rebalancing at a cross-over point. The balancing state of namespace rebalancing policy is not necessarily the balancing state of usage-based rebalancing policy, therefore the sudden change of the rebalance policy at the cross-over point will cause the high CPU and memory usage in rebalancing. The distributed storage network will take a lot of time to complete rebalancing the storage devices from the namespace range balancing state to the usage-based balancing state, and so will the change from the usage-based balancing state to the namespace range balancing state. Depending on the distributed storage network, the rebalancing could take a few days, a few weeks, and even a few months.

In exemplary embodiments, a hybrid rebalancing policy is used for determining whether to rebalance data stored across storage devices in a distributed storage network. The hybrid rebalancing policy is created by combining the behaviors of both a namespace rebalancing policy and a usage-based rebalancing policy together. When the average fullness of storage devices is low, the hybrid rebalancing policy behaves like the namespace range rebalancing policy. Likewise, when the average fullness is high, the hybrid rebalancing policy behaves like the usage-based rebalancing policy. In the middle (i.e. fullness is not very high and nor very low), the hybrid rebalancing policy behaves like a mix of namespace range rebalancing and usage-based rebalancing policies. For example, the higher the average fullness, the hybrid rebalancing policy behaves more like the usage-based rebalancing policy, and the lower the average fullness, the hybrid rebalancing policy behaves more like the namespace range rebalancing policy. In exemplary embodiments, as the average fullness of the storage devices increases from 0% to 100%, the hybrid rebalancing policy smoothly transitions from the namespace range rebalancing policy to the mix of namespace range and usage rebalancing policies and finally to the usage-based rebalancing policy. Likewise, as the average fullness of the storage devices decreases from 100% to 0%, the hybrid rebalancing policy smoothly transitions from the usage-based rebalancing policy to the mix of namespace range and usage rebalancing policies and finally to the namespace range rebalancing policy.

In exemplary embodiments, to quantify the imbalance of the usage of a storage device, the average fullness is calculated by the summation of all the storage device usages divided by the summation of all the storage device capacities. For each storage device, the balanced usage is calculated by multiplying average fullness to its capacity. A usage imbalance factor is defined as the ratio of the actual usage of a storage device to its balanced usage, i.e., the usage imbalance factor=actual usage/balanced usage. As a result, if a storage device is balanced, the usage imbalance should have a value of one, If the usage imbalance is larger or less than one, the storage device is imbalanced. If the usage imbalance is larger than one, the storage device is overfilled and if the usage imbalance is less than one, the storage device is underfilled. The larger the difference between the value of the usage imbalance and one, the greater the imbalance in the storage device.

In exemplary embodiments, to quantify the namespace range portion that a storage device owns, the width of the balanced namespace range portion is calculated by the width of the whole namespace range multiplied by the ratio of this storage device capacity to the summation of all storage device capacities. For each storage device, a namespace range imbalance factor is defined as the ratio of the actual namespace range width to the balanced namespace range width, i.e., the range imbalance factor=actual range width/balanced range width. Similar to the usage imbalance, if the range imbalance of a storage device has a value of one, the storage device has a balanced namespace range. If the range imbalance of a storage device is larger or less than one, the storage device has an imbalanced namespace range portion. The larger the range imbalance is than one, the wider the namespace range portion the storage device owns than the balanced namespace range portion. The smaller the range imbalance is than one, the narrower the namespace range portion the storage device owns than the balanced namespace range portion.

In exemplary embodiments, the namespace range imbalance factor and the usage imbalance factor are combined into a combined imbalance factor. The combined imbalance factor is calculated as combined imbalance factor=range weight*range imbalance factor+(1−range weight)*usage imbalance factor, where the range weight is the weight of namespace range imbalance in the combined imbalance, and (1—range weight) is the weight of usage imbalance. In exemplary embodiments, the range weight is defined based on the following:
range weight=1 for average fullness<=namespace only threshold;
range weight=0.5+sign*pow(abs(cos(x*PI)), balance adjustment)/2 for namespace only threshold<average fullness<usage only threshold; and
range weight=for average fullness>=usage only threshold.
   The namespace only threshold and the usage only threshold are user configurable thresholds for the namespace range only and usage-based only rebalancing, The namespace only threshold is less than the usage only threshold. x is defined as (average fullness−namespace only threshold)/(usage only threshold−namespace only threshold). Sign is the sign of cos(x*PI), and sign has a value of 1 when cos(x*PD)>=0, and sign has a value of −1 when cos(x*PI)<=0. The balance adjustment is a user-configurable parameter that is configured to adjust the behavior of range weight with the change of average fullness.

Referring now to FIG. 11, a graph illustrating the relationship between the range weight and the average fullness for different values of the balance adjustment in accordance with an embodiment is shown. The graph illustrates the behavior of range weight versus average fullness for different values of balance adjustment, where the namespace only threshold is 0.1 and the usage only threshold is 0.9. As illustrated, with the increase of average fullness from 0% to 100%, the range weight is smoothly changed from 1 to 0, so that combined imbalance is smoothly changed from the namespace range imbalance to the combination of namespace range and usage imbalances, and finally usage imbalance. Therefore, the behavior of rebalancing based on the combined imbalance also smoothly transitions from the namespace range rebalancing like behavior, to the mix of namespace range and usage-based rebalancing behaviors, and the usage-based rebalancing like behavior; vice versa.

In exemplary embodiments, a determination is made as to whether the storage devices associated with a namespace need to be rebalanced based on an imbalance ratio, which is a relative ratio of the maximum and minimum values of the combined imbalance. The imbalance ratio is calculated as imbalance ratio=(max combined imbalance−min combined imbalance)/max combined imbalance. In exemplary embodiments, if the imbalance ratio is larger than or equal to a given/configurable rebalancing threshold (e.g., 0.02), the hybrid rebalancing method is executed.

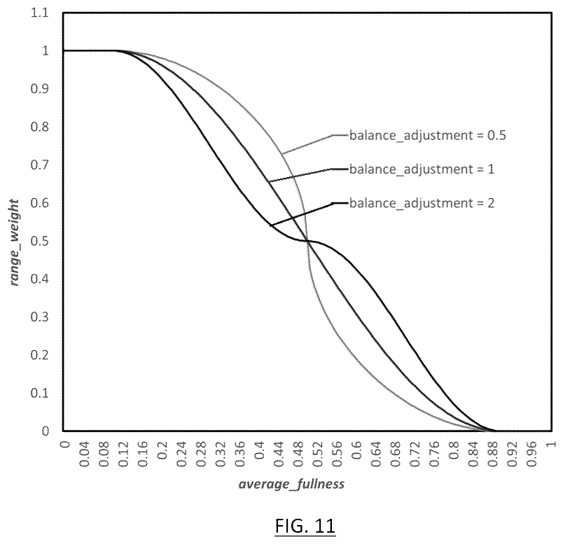

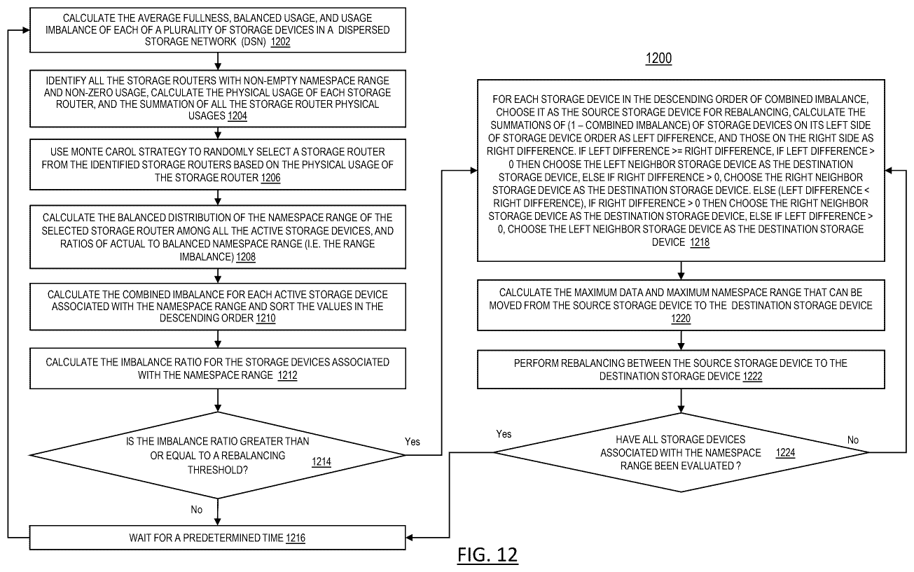

Referring now to FIG. 12, a flowchart diagram illustrating a method 1200 for performing rebalancing in a distributed storage network based on a combination of namespace range and usage imbalances in accordance with an embodiment of the present disclosure is shown. In exemplary embodiments, the method 1200 is performed in each of the storage units 36, respectively, as shown in FIG. 1. The method 1200 begins at block 1202 by calculating the average fullness, balanced usage, and usage imbalance of each of a plurality of storage devices in a dispersed storage network (DSN). In exemplary embodiments, the DSN includes a plurality of storage router and each storage router is associated with a namespace that is allocated in the DSN. The entire namespace of the DSN includes the namespaces associated with each of the storage routers in the DSN. Next, as shown at block 1204, the method 1200 includes identifying all the storage routers with non-empty namespace range and non-zero usage and calculating the physical usage of each storage router and the summation of all the storage router physical usages.

As shown at block 1206, the method 1200 includes selecting a storage router from the identified storage routers probabilistically based on the physical usage of the storage router. In one example, a Monte Carlo approach is used to randomly select the storage router based on their relative usages so that the larger is the usage of a storage router, the higher the chance is it to be selected. Once a storage router, and its associated namespace have been selected, the method 1200 proceeds to block 1208 and includes calculating the balanced distribution of the namespace range of the selected storage router among all the active storage devices, and ratios of actual to balanced namespace range (i.e. the range imbalance). Next, as shown at block 1210, the method 1200 includes calculating the combined imbalance for each active storage device associated with the namespace range and sorting the combined imbalance values in descending order, At block 1212 the imbalance ratio for the storage devices associated with the namespace range (e.g., for the storage router) is calculated.

At decision block 1214, the method 1200 determines whether the imbalance ratio is greater than or equal to a rebalancing threshold. Based on a determination that the imbalance ratio is not greater than or equal to the rebalancing threshold, the method 1200 proceeds to block 1216 and waits for a predetermined time before returning to block 1202. Otherwise, the method 1200 proceeds to block 1218, and for each storage device in the descending order of combined imbalance, choose it as the source storage device for rebalancing, calculate the summations of (1−combined imbalance) of storage devices on its left side of storage device order as left difference, and those on the right side as right difference. If left difference>=right difference, if left difference>0 then choose the left neighbor storage device as the destination storage device, else if right difference>0, choose the right neighbor storage device as the destination storage device. Else (left difference<right difference), if right difference>0 then choose the right neighbor storage device as the destination storage device, else if left difference>0, choose the left neighbor storage device as the destination storage device.

As shown at block 1220, the method 1200 includes calculating the maximum data and maximum namespace range that can be moved from the source storage device to the destination storage device, The method 1200 also includes performing rebalancing between the source storage device to the destination storage device, as shown at block 1222. At decision block 1224, the method 1200 includes determining whether all storage devices associated with the namespace range have been evaluated. Based on a determination that all storage devices associated with the namespace range have been evaluated, the method 1200 proceeds to block 1216 and waits for a predetermined time before returning to block 1202. Otherwise, the method 1200 returns to block 1218 and selects another source storage device for evaluation.

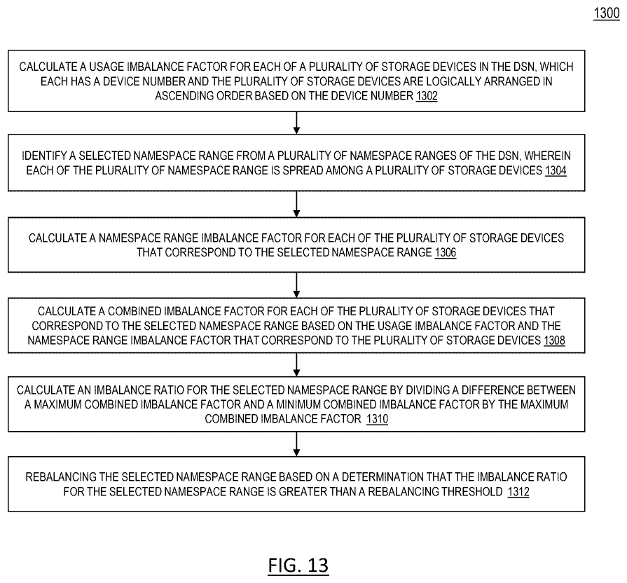

Referring now to FIG. 13, a flowchart diagram illustrating a method 1300 for performing rebalancing in a distributed storage network based on a combination of namespace range and usage imbalances in accordance with an embodiment of the present disclosure is shown. In exemplary embodiments, the method 1300 is performed in each of the storage units 36, respectively, as shown in FIG. 1. The method 1300 begins at block 1302 by calculating a usage imbalance factor for each of a plurality of storage devices in the distributed storage network (DSN). In exemplary embodiments, each storage device has a device number and the plurality of storage devices are logically arranged in ascending order based on the device number. In exemplary embodiments, the usage imbalance factor for a storage device is calculated as an actual usage of the storage device divided by a balanced usage of the storage device.

Next, as shown at block 1304, the method 1300 includes identifying a selected namespace range from a plurality of namespace ranges of the DSN. In exemplary embodiments, each of the plurality of namespace ranges is spread among a plurality of storage devices. In exemplary embodiments, the selected namespace range is identified from the plurality of namespace ranges of the DSN based on a relative amount of usage of the plurality of namespace ranges by Monte Carlo strategy.

As shown at block 1306, the method 1300 includes calculating a namespace range imbalance factor for each of the plurality of storage devices that correspond to the selected namespace range. In exemplary embodiments, the namespace imbalance factor for a storage device is calculated as a maximum namespace address minus a minimum namespace address divided by an ideal maximum namespace address minus an ideal minimum namespace address. Next, as shown at block 1308, the method 1300 includes calculating a combined imbalance factor for each of the plurality of storage devices that correspond to the selected namespace range based on the usage imbalance factor and the namespace range imbalance factor that corresponds to the plurality of storage devices. In exemplary embodiments, the combined imbalance factor for each of the plurality of storage devices is calculated as a range weight multiplied by the range imbalance factor plus the usage imbalance factor multiplied by one minus the range weight.

In exemplary embodiments, the range weight is one based on an average fullness of the plurality of storage devices in the DSN being less than a namespace rebalancing threshold value and the range weight is zero based on the average fullness being greater than a usage rebalancing threshold. In one embodiment, based on the average fullness of the plurality of storage devices being greater than the namespace rebalancing threshold and less than the usage rebalancing threshold, the range weight is calculated as: 0.5+sign*pow(abs(cos(x*PI)), a balance adjustment)/2, where x is calculated as (the average fullness−namespace rebalancing threshold)/(usage rebalancing threshold−namespace rebalancing threshold), sign is the sign of cos(x*PI), and the balance adjustment is user configurable parameter.

As shown at block 1310, the method 1300 includes calculating an imbalance ratio for the selected namespace range by dividing a difference between a maximum combined imbalance factor and a minimum combined imbalance factor by the maximum combined imbalance factor. The method 1300 includes rebalancing the selected namespace range based on a determination that the imbalance ratio for the selected namespace range is greater than a rebalancing threshold, as shown a block 1312. The method 1300 also includes determining that rebalancing the selected namespace range is not required based on a determination that the imbalance ratio for the selected namespace range is not greater than a rebalancing threshold.

In exemplary embodiments, rebalancing the selected namespace range includes identifying a source storage device of the DSN, where the source storage device of the DSN is identified based on a determination that it has the largest namespace imbalance factor. The rebalancing also includes identifying one of the left neighbor storage device of the DSN and a right neighbor storage device of the DSN as a destination storage device of the DSN, wherein the device number of the left neighbor storage device is one less than the device number of the source storage device and the device number of the right neighbor storage device is one greater than the device number of the source storage device. The rebalancing also includes reassigning a portion of the selected namespace range from the source storage device to a destination storage device of the DSN. In exemplary embodiments, the identification of the destination device is based on a comparison of combined imbalance factors of the left neighbor storage device and the right neighbor storage device.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for rebalancing of a distributed storage network (DSN) based on a combination of namespace range and usage imbalances, the method comprising:
calculating a usage imbalance factor for each of a plurality of storage devices in the DSN, which each has a device number and the plurality of storage devices are logically arranged in ascending order based on the device number;
identifying a selected namespace range from a plurality of namespace ranges of the DSN, wherein each of the plurality of namespace ranges is spread among the plurality of storage devices;
calculating a namespace range imbalance factor for each of the plurality of storage devices that correspond to the selected namespace range;
calculating a combined imbalance factor for each of the plurality of storage devices that correspond to the selected namespace range based on the usage imbalance factor and the namespace range imbalance factor that correspond to the plurality of storage devices;
calculating an imbalance ratio for the selected namespace range by dividing a difference between a maximum combined imbalance factor and a minimum combined imbalance factor by the maximum combined imbalance factor; and
based on a determination that the imbalance ratio for the selected namespace range is greater than a rebalancing threshold, rebalancing the selected namespace range.

2. The method of claim 1, wherein rebalancing the selected namespace range comprises:
identifying a source storage device of the DSN, wherein the source storage device of the DSN is identified based on a determination that it has a largest namespace imbalance factor; and
identifying one of a left neighbor storage device of the DSN and a right neighbor storage device of the DSN as a destination storage device of the DSN, wherein the device number of the left neighbor storage device is one less than the device number of the source storage device and the device number of the right neighbor storage device is one greater than the device number of the source storage device; and
copying data and reassigning a portion of the selected namespace range from the source storage device to a destination storage device of the DSN.

3. The method of claim 2, wherein the identification of the destination device is based on a comparison of combined imbalance factors of the left neighbor storage device and the right neighbor storage device.

4. The method of claim 1, wherein the selected namespace range is identified from the plurality of namespace ranges of the DSN based on a relative amount of usage of the plurality of namespace ranges.

5. The method of claim 1, wherein the combined imbalance factor for each of the plurality of storage devices is calculated as a range weight multiplied by the range imbalance factor plus the usage imbalance factor multiplied by one minus the range weight.

6. The method of claim 5, wherein the range weight is one based on an average fullness of the plurality of storage devices in the DSN being less than a namespace rebalancing threshold value and the range weight is zero based on the average fullness being greater than a usage rebalancing threshold.

7. The method of claim 6, wherein based on the average fullness of the plurality of storage devices being greater that the namespace rebalancing threshold and less than the usage rebalancing threshold, the range weight is calculated as: 0.5+sign*pow(abs(cos(x*PI)), a balance adjustment)/2, where x is calculated as (an average fullness−namespace rebalancing threshold)/(usage rebalancing threshold−namespace rebalancing threshold), sign is the sign of cos(x*PI), and the balance adjustment is user configurable parameter.

8. The method of claim 1, wherein the namespace imbalance factor for a storage device is calculated as a maximum namespace address minus a minimum namespace address divided by an ideal maximum namespace address minus an ideal minimum namespace address.

9. The method of claim 1, wherein the usage imbalance factor for a storage device is calculated as an actual usage of the storage device divided by a balanced usage of the storage device.

10. The method of claim 1, further comprising determining that rebalancing the selected namespace range is not required based on a determination that the imbalance ratio for the selected namespace range is not greater than a rebalancing threshold.

11. A computing system having a memory having computer readable instructions and one or more processors for executing the computer readable instructions, the computer readable instructions controlling the one or more processors to perform operations comprising:
calculating a usage imbalance factor for each of a plurality of storage devices in a distributed storage network (DSN), which each has a device number and the plurality of storage devices are logically arranged in ascending order based on the device number;
identifying a selected namespace range from a plurality of namespace ranges of the DSN, wherein each of the plurality of namespace ranges is spread among the plurality of storage devices;
calculating a namespace range imbalance factor for each of the plurality of storage devices that correspond to the selected namespace range;
calculating a combined imbalance factor for each of the plurality of storage devices that correspond to the selected namespace range based on the usage imbalance factor and the namespace range imbalance factor that correspond to the plurality of storage devices;
calculating an imbalance ratio for the selected namespace range by dividing a difference between a maximum combined imbalance factor and a minimum combined imbalance factor by the maximum combined imbalance factor; and
based on a determination that the imbalance ratio for the selected namespace range is greater than a rebalancing threshold, rebalancing the selected namespace range.

12. The computing system of claim 11, wherein rebalancing the selected namespace range comprises:
identifying a source storage device of the DSN, wherein the source storage device of the DSN is identified based on a determination that it has a largest namespace imbalance factor; and
identifying one of a left neighbor storage device of the DSN and a right neighbor storage device of the DSN as a destination storage device of the DSN, wherein the device number of the left neighbor storage device is one less than the device number of the source storage device and the device number of the right neighbor storage device is one greater than the device number of the source storage device; and
copying data and reassigning a portion of the selected namespace range from the source storage device to a destination storage device of the DSN.

13. The computing system of claim 12, wherein the identification of the destination device is based on a comparison of combined imbalance factors of the left neighbor storage device and the right neighbor storage device.

14. The computing system of claim 11, wherein the selected namespace range is identified from the plurality of namespace ranges of the DSN based on a relative amount of usage of the plurality of namespace ranges.

15. The computing system of claim 11, wherein the combined imbalance factor for each of the plurality of storage devices is calculated as a range weight multiplied by the range imbalance factor plus the usage imbalance factor multiplied by one minus the range weight.

16. The computing system of claim 15, wherein the range weight is one based on an average fullness of the plurality of storage devices in the DSN being less than a namespace rebalancing threshold value and the range weight is zero based on the average fullness being greater than a usage rebalancing threshold.

17. The computing system of claim 16, wherein based on the average fullness of the plurality of storage devices being greater that the namespace rebalancing threshold and less than the usage rebalancing threshold, the range weight is calculated as: 0.5+sign*pow(abs(cos(x*PI)), a balance adjustment)/2, where x is calculated as (an average fullness−namespace rebalancing threshold)/(usage rebalancing threshold−namespace rebalancing threshold), sign is the sign of cos(x*PI), and the balance adjustment is user configurable parameter.

18. The computing system of claim 11, wherein the namespace imbalance factor for a storage device is calculated as a maximum namespace address minus a minimum namespace address divided by an ideal maximum namespace address minus an ideal minimum namespace address.

19. The computing system of claim 11, wherein the usage imbalance factor for a storage device is calculated as an actual usage of the storage device divided by a balanced usage of the storage device.

20. A computer program product comprising a computer readable storage medium having program instructions embodied therewith, the program instructions executable by a processor to cause the processor to perform operations comprising:
calculating a usage imbalance factor for each of a plurality of storage devices in a distributed storage network (DSN), which each has a device number and the plurality of storage devices are logically arranged in ascending order based on the device number;
identifying a selected namespace range from a plurality of namespace ranges of the DSN, wherein each of the plurality of namespace ranges is spread among the plurality of storage devices;
calculating a namespace range imbalance factor for each of the plurality of storage devices that correspond to the selected namespace range;
calculating a combined imbalance factor for each of the plurality of storage devices that correspond to the selected namespace range based on the usage imbalance factor and the namespace range imbalance factor that correspond to the plurality of storage devices;
calculating an imbalance ratio for the selected namespace range by dividing a difference between a maximum combined imbalance factor and a minimum combined imbalance factor by the maximum combined imbalance factor; and
based on a determination that the imbalance ratio for the selected namespace range is greater than a rebalancing threshold, rebalancing the selected namespace range.
